(19) United States
(12) Patent Application Publication
(10) Pub. No.: US 2026/0148263 A1
(43) Pub. Date: May 28, 2026

(54) USED VEHICLE APPRAISAL SYSTEM, INFORMATION PROCESSING DEVICE, AND METHOD FOR APPRAISING USED VEHICLE

(71) Applicants: Nobutaka SUZUKI, New Taipei City (CN); CARNEWSNET CO., LTD., Taiwan (CN)

(72) Inventor: Nobutaka SUZUKI, Taiwan (CN)

(73) Assignees: Nobutaka SUZUKI, New Taipei City (CN); CARNEWSNET CO., LTD., Taiwan (CN)

(21) Appl. No.: 19/455,081

(22) Filed: Jan. 21, 2026

Related U.S. Application Data
(63) Continuation of application No. PCT/JP2023/036418, filed on Oct. 5, 2023.

(51) Int. Cl. G06Q 30/02

(52) U.S. Cl. CPC G06Q 30/0278

(57) ABSTRACT

A used vehicle appraisal system includes an information processing device that is communicably connected to a memory that stores appraisal ratings of used vehicles linked to category information on the used vehicles. The information processing device determines a category of used vehicles with the same elapsed period as a target vehicle based on information on the elapsed period, extracts pieces of comparative information belongs to the category from the appraisal information in the memory and determines whether the number of the pieces of the comparative information is two or greater than a predefined number, in response to determination of the number greater than the predefined number, calculates statistics of the appraisal ratings based on the comparative information for main items, generates information on comparisons between the appraisal ratings and the statistics, and in response to determination of the number less than the predefined number, halts calculation and information generation.

### CROSS-REFERENCE TO RELATED APPLICATION

The present application is a continuation of International Patent Application No. PCT/JP2023/036418 filed on Oct. 5, 2023, the entire contents of which are incorporated herein by reference.

### TECHNICAL FIELD

The present disclosure relates to a used vehicle appraisal system, an information processing device, and a method for appraising a used vehicle.

### BACKGROUND

A system for appraising used vehicles has been known. An example of such a system is described in Japanese Unexamined Patent Application Publication No. 2013-25722

A technology for generating proper appraisal information on used vehicles to provide potential used vehicle buyers with materials that would be assistance in decision-making of the potential used vehicle buyers still has room for improvement.

### SUMMARY

An objective of the present disclosure is to provide a used vehicle appraisal system, an information processing device, a program, and a method for appraising a used vehicle for generating proper appraisal information on used vehicles.

A used vehicle appraisal system in this disclosure includes a memory and an information processing device that is communicably connected to the memory. The memory stores a number of pieces of appraisal information that includes appraisal ratings of used vehicles linked to category information on the used vehicles. The category information includes categories to which the used vehicles belongs. The categories include a category of used vehicle model and a category of elapsed period since production of a vehicle until an appraisal of the vehicle. The appraisal ratings are for at least two of main items for appraisal including used vehicle exterior, used vehicle interior, engine or motor in the used vehicle, used vehicle frame, used vehicle tire wear rate, and used vehicle air conditioning. The information processing device performs a determining process, an extracting process, a statistics calculating process, an information generating process, and a halting process. The determining process is for determining a category of the used vehicles, an elapsed period of which is the same as a target vehicle, as a category to which the target vehicle belongs based on information on the elapsed period regardless of model years of the used vehicles. The extracting process is for extracting pieces of comparative information that corresponds to pieces of the appraisal information on the used vehicles that belongs to the category from the appraisal information stored in the memory and determining whether the number of the pieces of the comparative information is 2 or greater than a predefined number. The statistics calculating process is for calculating statistics of the appraisal ratings of the used vehicles linked to the pieces of the comparative information based on the pieces of the comparative information for the main items, respectively, in response to determination of the number of the pieces of the comparative information greater than the predefined number. The information generating process is for generating information on comparisons between the appraisal ratings of the target vehicle and the statistics for the main items, respectively. The halting process is for halting the statistics calculating process and the information generating process in response to determination of the number of the pieces of the comparative information less than the predefined number.

In appraisals of used vehicles, appraisal ratings are determined based on comparison with conditions of a new vehicle that does not have any scars and degradation as standard. If the used vehicle has scars or degradation, the appraisal ratings are deducted. According to such a method of appraisals with the conditions of the new vehicle as standard, appraisal ratings of used vehicles tend to be lower as elapsed years since production of the used vehicle increases.

Durability of new vehicles has been improved more than before. Although certain years have passed since production of vehicles, some used vehicles are still in good condition. When appraisals are performed based on the comparison with the conditions of the new vehicle as standard, appraisal ratings of the used vehicles tend to be lower as elapsed years since production of the used vehicle increases. Even if the used vehicles are in good condition, the appraisals of the used vehicles are lower in comparison to new vehicles in the same models.

Potential used vehicle buyers normally understand that degrees of scars or degradation increase as elapsed years of used vehicles increase. Relative appraisal information that indicates how much a used vehicle in model that a potential buyer targets on for an appraisal is superior or inferior to the used vehicles in the same category as the target used vehicle would be assistance in decision-making of the potential buyer.

The information processing device in the present disclosure generates information on comparison between appraisal ratings of a target vehicle that is a used vehicle to be appraised and statistics (e.g., means) of appraisal ratings of used vehicles in the category to which the target vehicle belongs. The potential buyer can use the relative appraisal information on the target vehicle relative to the used vehicles in the same category.

At least one of elapsed period information and total mileage information may be used as the category information for determining the category of the used vehicles. According to the configuration, the relative appraisal information on the target vehicle relative to the used vehicles with scars and degradation in degrees as similar as possible to the target vehicle is generated.

According to the present disclosure described above, proper appraisal information on used vehicle is generated.

### BRIEF DESCRIPTION OF THE DRAWINGS

FIG. 1 is a view illustrating an overall configuration of a used vehicle appraisal system.

FIG. 2 is a flowchart illustrating steps of a registering process for registering appraisal information in the IDC server.

FIG. 3 is a view illustrating category information.

FIG. 4 is a view illustrating appraisal items for a vehicle exterior of a used vehicle.

FIG. 5 is a view illustrating appraisal items for a vehicle interior of a used vehicle.

FIG. 6 is a view illustrating appraisal items for an engine of a used vehicle.

FIG. 7 is a view illustrating appraisal items for a frame of a used vehicle.

FIG. 8 is a flowchart illustrating steps of an appraisal process for the used vehicle.

FIG. 9 is a view illustrating an example of classification based on total mileage.

FIG. 10 is a view illustrating an example of a used vehicle relative appraisal report.

FIG. 11 is a view illustrating an example of a used vehicle relative appraisal report.

### DETAILED DESCRIPTION OF EMBODIMENTS

An embodiment of a used vehicle appraisal system according to the disclosure herein will be described with reference to the drawings. The appraisal system in this embodiment may be used by a service provider who holds appraisal information on a number of used vehicles for providing used vehicle appraisal services to used vehicle dealers who buy and sell used vehicles.

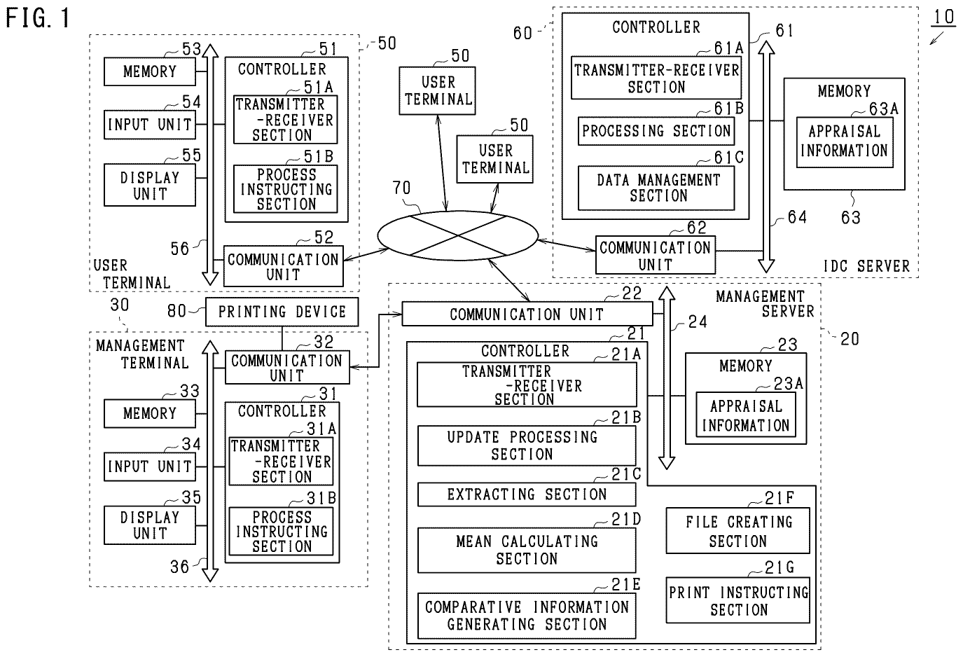

An overall configuration of an appraisal system 10 is illustrated in FIG. 1. The appraisal system 10 includes a management server 20, a management terminal 30, user terminals 50, and an internet data center (IDC) server 60. The management server 20 and the management terminal 30 are managed by a management company that provides the appraisal services. Examples of the management terminal 30 include desktop computers and laptop computers. The management terminal 30 and the management server 20 are communicably connected to each other.

The user terminals 50 are managed by the used vehicle dealers. The user terminals 50 may be operated by used vehicle appraisers who belong to the used vehicle dealers or used vehicle appraisers who are partners with the used vehicle dealers. The user terminals 50 in this embodiment are mobile devices that are carried by the appraisers such as smartphones and tablet computers. The number of the user terminals 50 is defined based on the number of the used vehicle dealers.

The management server 20, the user terminals 50, and the IDC server 60 are communicably connected to one another via a communication network 70 (e.g., internet). The communication network 70 is at least one of a wire network and a wireless network.

The management server 20 performs various kinds of processes related to appraisal services. The management server 20 includes a controller 21, a communication unit 22, and a memory 23. The controller 21 includes a processor that is hardware and executes appraisal service programs. The communication unit 22 has an interface with external communication devices for transmitting and receiving data to and from the external communication devices. In the management server 20, the controller 21, the communication unit 22, and the memory 23 are communicably connected to one another via a communication bus 24.

The memory 23 includes a memory unit and a storage unit that are hardware. The memory unit is for storing data that is used in the processing that is performed by the management server 20. The memory unit may provide the processor with work areas for temporary use in processing that is performed by the processor. Example of the memory unit include a ROM and a RAM. The storage unit is for storing data and various programs that are read out and executed by the processor. Examples of the storage unit include a HDD and a flash memory. The storage unit stores program information for the appraisal services. Program information that is stored in a storage medium may be installed into the memory 23. Examples of the storage medium include a USB memory and a CD-ROM. Program information transmitted through the communication network 70 may be installed into the memory 23.

The communication unit 22 transmits and receives data via the communication network 70. The communication unit 22 transmits data to other devices according to instructions from the controller 21. The communication unit 22 receives data from other devices and transmits the data to at least one of the controller 21 and the memory 23.

The management terminal 30 is operated by a representative of the management company. The management terminal 30 has a configuration that includes a controller 31, a communication unit 32, and a memory 33, which is similar to the configuration of the management server 20. The management terminal 30 further includes an input unit 34 and a display unit 35. In the management terminal 30, the controller 31, the communication unit 32, and the memory 33 are communicably connected to one another via a communication bus 36.

The memory 33 includes a memory unit and a storage unit. The controller 31 includes a processor and controls operations of the management terminal 30 by reading out programs stored in the memory 33 and executing the programs. The communication unit 32 transmits and receives data to and from the management server 20 via the communication unit 22 in the management server 20. The communication unit 32 transmits data to the management server 20 according to instructions from the controller 31. The communication unit 32 receives data transmitted from the management server 20 and transmits the data to at least one of the controller 31 and the memory 33.

The input unit 34 is operated by the representative of the management company. The input unit 34 accepts input operations of the representative and transmits information related to the accepted input operations to the controller 31. Examples of the input unit 34 include hardware keys such as a touch panel, a touch screen, and a keyboard, and a pointing device such as a mouse. The display unit 35 displays results of processing that is performed by the controller 31. Examples of the display unit 35 include a touch panel, a touch screen, and a desktop display.

Each of the user terminals 50 has a configuration that includes a controller 51, a communication unit 52, a memory 53, an input unit 54, and a display unit 55, which is similar to the configuration of the management terminal 30. In each of the user terminals 50, a controller 51, a communication unit 52, a memory 53, an input unit 54, and a display unit 55 are communicably connected to one another via a communication bus 56.

The input unit 54 is operated by an appraiser. The input unit 54 accepts input operations that are performed by the appraiser and transmits information related to the accepted input operations to the controller 51. Examples of the input unit 54 include a touch panel, a touch screen, and hardware keys.

The memory 53 includes a memory unit and a storage unit. The controller 51 includes a processor and controls operations of the user terminals 50 by reading out programs stored in the memory 53 and executing the programs. The communication unit 52 transmits and receives data via the communication network 70. The communication unit 52 transmits data to other devices according to instructions from the controller 51. The communication unit 52 receives data from other devices and transmits the data to at least one of the controller 51 and the memory 53.

The IDC server 60 has a configuration that includes a controller 61, a communication unit 62, and a memory 63, which is similar to the configuration of the management server 20. In the IDC server 60, the controller 61, the communication unit 62, and the memory 63 are connected to one another via a communication bus 64.

The memory 63 includes a memory unit and a storage unit. The controller 61 includes a processor and controls operations of the IDC server 60 by reading out programs stored in the memory 63 and executing the programs. The communication unit 62 transmits and receives data via the communication network 70. The communication unit 62 transmits data to other devices according to instructions from the controller 61. The communication unit 62 receives data from other devices and transmits the data to at least one of the controller 61 and the memory 63.

The appraisal system 10 includes a printing device 80 that prints out documents related to the used vehicle appraisal services. The printing device 80 is managed by the management company and communicably connected to the communication unit 32 in the management terminal 30. Examples of the printing device 80 include a laser printer and an inkjet printer.

An overview of the used vehicle appraisal services that are provided through the management server 20 will be described.

The memory 63 in the IDC server 60 stores a number of pieces of appraisal information 63A on used vehicles. A number of pieces of appraisal information 63A from a number of the user terminals 50 are accumulated in a database in the memory 63.

A number of pieces of the appraisal information 63A stored in the memory 63 in the IDC server 60 is periodically (specifically on a daily basis) downloaded to the memory 23 in the management server 20. That is, a number of pieces of the appraisal information 23A stored in the memory 23 in the management server 20 is periodically updated.

The controller 21 in the management server 20 generates relative appraisal report data for a target vehicle based on the appraisal information 23A stored in the memory 23. The target vehicle is a used vehicle that is to be appraised and that the used vehicle dealer requests an appraisal. The generated relative appraisal report data may be printed out through the printing device 80 and the printed data on a paper medium is mailed from the management company to the used vehicle dealer. The generated relative appraisal report data in a specific digital format (e.g., a PDF file) may be transmitted to the user terminal 50 or a user terminal other than the user terminal 50 via the communication network 70.

### Process for Registering Appraisal Information Using User Terminal 50

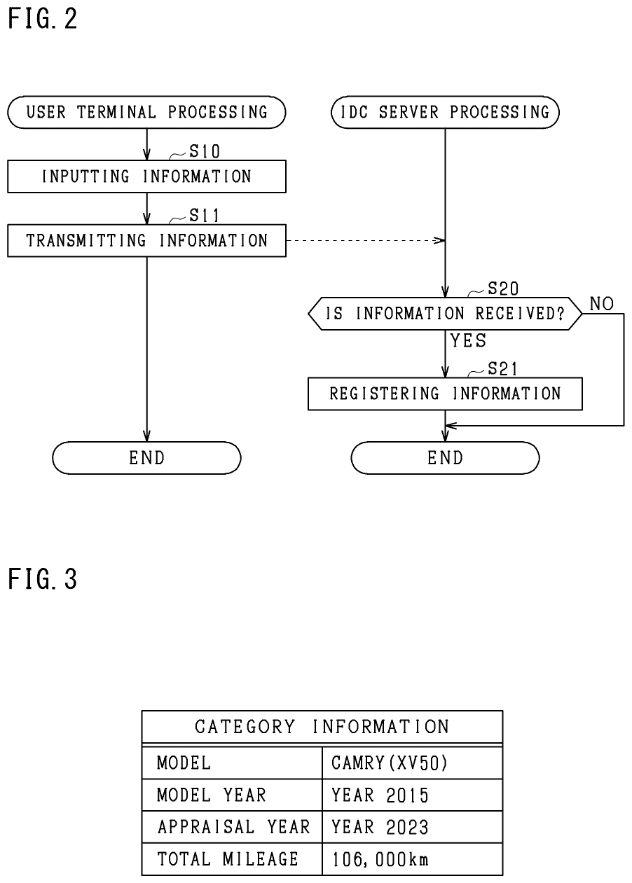

First, an appraisal information registering process will be described. The controller 51 in the user terminal 50 reads out an appraisal information registering program stored in the memory 53 and executes the program to perform functions of a transmitter-receiver section 51A and a process instructing section 51B. FIG. 2 is a flowchart illustrating steps of the appraisal information registering process.

Through operation of the input unit 54 in the user terminal 50 by the appraiser, the process instructing section 51B activates an appraisal information registering application. In step S10, the process instructing section 51B controls the display unit 55 in the user terminal 50 to display an input screen for input of the appraisal information. The input screen includes input cells in which pieces of the appraisal information on the used vehicle are inputted. The appraiser operates the input unit 54 to input the pieces of the appraisal information in the input cells.

In this embodiment, the input screen includes input cells for items (A1) to (A5) are provided (see FIG. 3). Items (A1) to (A5) are related to category information on the used vehicle.
(A1) Used vehicle model information

Model information includes vehicle manufacturer and vehicle model.

Examples of the model information include “HONDA: CR-V (registered trademark),” “NISSAN: X-TRAIL (registered trademark),” and “TOYOTA: PRIUS (registered trademark).” FIG. 3 illustrates an example of model information “TOYOTA:CAMRY (XV50).”

In this embodiment, models are not classified based on vehicle grades or models of the vehicles before and after minor changes but on models before and after major changes of the vehicles. That is, the model information includes information on models of used vehicles according to major changes but not grade information on the used vehicles and model information on models of the used vehicles according to minor changes.
(A2) Model year information

Model year information indicates years of production of the vehicles. If a period between the actual production of the vehicle and the first registration date of the vehicle (e.g., the date of registration to the administration) is within specified months (e.g., three months, four months, or five months), the year of the registration of the vehicle may be entered as model year information.
(A3) Appraisal year information

Appraisal year information indicates year of appraisal of the used vehicle performed by the appraiser. The appraisal year information and the model year information are used for generating vehicle age (or elapsed period) information on the used vehicle. The vehicle age information indicates the number of elapsed years (or elapsed period) since production of the vehicle until the appraisal of the vehicle.

In this embodiment, the process instructing section 51B in the user terminal 50 generates the vehicle age information on the used vehicle based on the model year information and the appraisal year information that have been inputted. For example, if an appraisal of a 2011 model used vehicle was performed in 2019, an appraisal of a 2012 model used vehicle was performed in 2020, and an appraisal of a 2013 model used vehicle was performed in 2021, the vehicle age of each used vehicle is eight.
(A4) Used vehicle total mileage information

A total mileage is an accumulated distance traveled since the production of the vehicle until the appraisal of the vehicle. FIG. 3 illustrates an example of the total mileage of 106,000 km.
(A5) Appraisal ratings for main items

In this embodiment, main items include six items of “used vehicle exterior,” “used vehicle interior,” “used vehicle engine (internal combustion engine)” “used vehicle frame,” “used vehicle tire wear rate,” and “used vehicle air conditioning.”

Appraisal ratings are determined for six main items, respectively. In this embodiment, a five-grade evaluation system is used for determining the appraisal ratings. Specifically, each appraisal rating is determined out of ten points in steps of two points. The less the scars or degradation in appraisal portions, the higher the appraisal rating.

### Vehicle Exterior

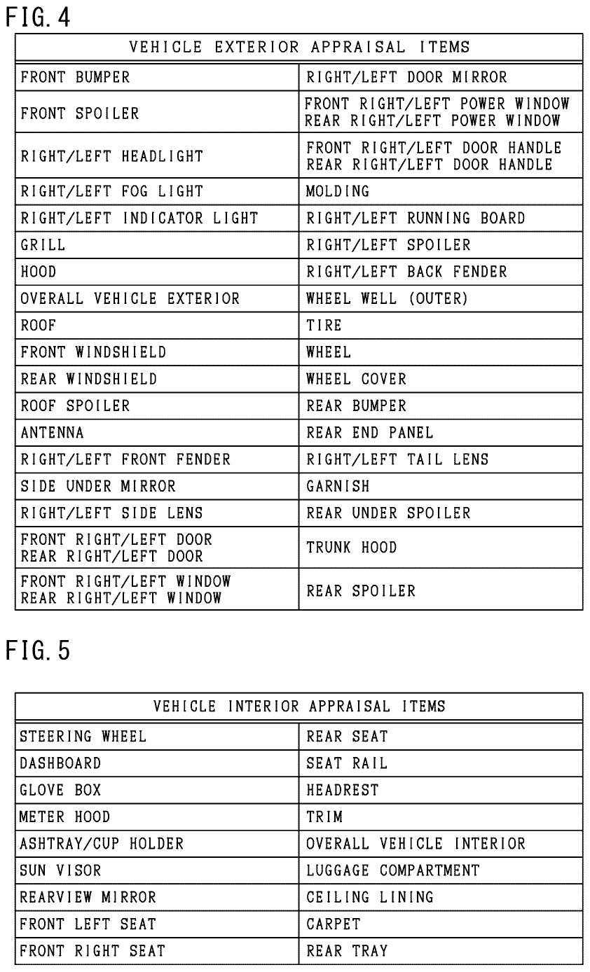

Detailed items for vehicle exterior are illustrated in FIG. 4. The detailed items for vehicle exterior include multiple items (specifically, thirty six items). The process instructing section 51B controls the display unit 55 to display the detailed items for vehicle exterior and input cells for inputting the appraisal ratings related to the detailed items for vehicle exterior. The process instructing section 51B obtains the appraisal ratings inputted in the input cells through the input unit 54 operated by the appraiser. The appraisal ratings related to the detailed items for vehicle exterior are determined according to the five-grade evaluation system, specifically, out of ten points in steps of two points.

The process instructing section 51B calculates an appraisal rating for the vehicle exterior based on the appraisal ratings inputted in the input cells corresponding to the detailed items (hereinafter referred to as an overall vehicle exterior appraisal rating). For example, the process instructing section 51B calculates the overall vehicle exterior appraisal rating based on the inputted appraisal ratings and an algorithm for calculating the overall vehicle exterior appraisal rating.

The appraiser performs input operations through the input unit 54 in the portable user terminal 50 for every time he or she inputs the appraisal ratings for the detailed items for the vehicle exterior. When the appraisal ratings are inputted, the user terminal 50 automatically calculates the overall vehicle exterior appraisal rating on which the appraisal ratings for the detailed items are reflected. Even if a number of the detailed items are provided, errors in calculation of the overall vehicle exterior appraisal rating can be reduced while workload of the appraiser is reduced.

An example of mode of input operations for the detailed items for vehicle exteriors will be described. The process instructing section 51B controls the display unit 55 to display a net drawing of a vehicle. If, for example, the process instructing section 51B determines that a front bumper in the net drawing is selected through tapping operation by an operator, the process instructing section 51B controls the display unit 55 to display an enlarged view of the font bumper and the input cells of the detailed items related to the front bumper. The operator can select appraisal ratings to be entered in the input cells through tapping operation.

### Vehicle Interior

Detailed items for vehicle interior are illustrated in FIG. 5. The detailed items for vehicle interior include multiple items (specifically, eighteen items). The process instructing section 51B controls the display unit 55 to display the detailed items for vehicle interior and input cells for inputting the appraisal ratings related to the detailed items for vehicle interior. The process instructing section 51B obtains the appraisal ratings inputted in the input cells through the input unit 54 operated by the appraiser. The appraisal ratings related to the detailed items for vehicle interior are determined according to a five-grade evaluation system, specifically, out of ten points in steps of two points.

The process instructing section 51B calculates an appraisal rating for vehicle interior based on the appraisal ratings inputted in the input cells corresponding to the detailed items (hereinafter referred to as an overall vehicle interior appraisal rating). For example, the process instructing section 51B calculates the overall vehicle interior appraisal rating based on the inputted appraisal ratings and an algorithm for calculating the overall vehicle interior appraisal rating. The appraiser performs input operations through the input unit 54 in the user terminal 50 for every time he or she inputs the appraisal ratings for the detailed items for the vehicle interior.

### Engine

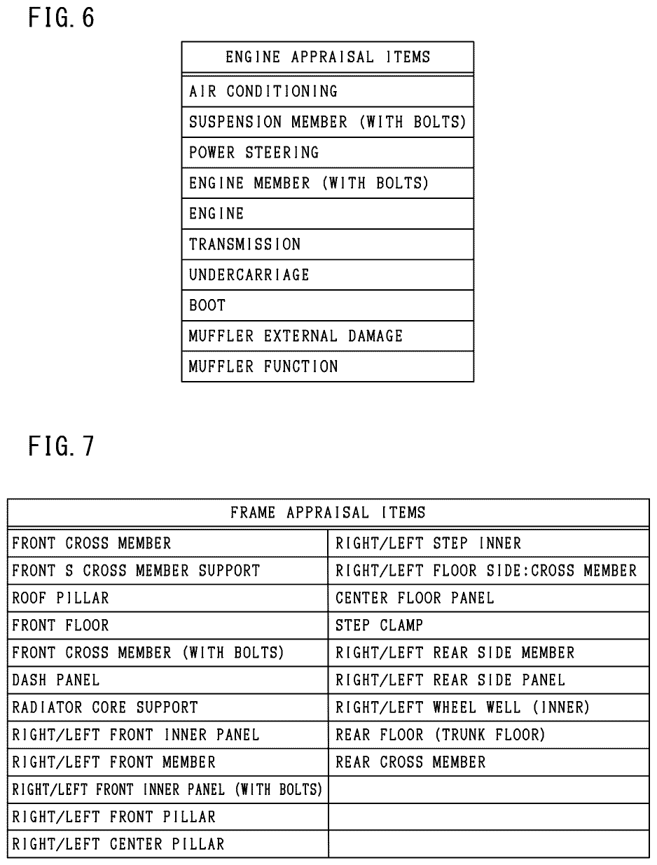

Detailed items for engine are illustrated in FIG. 6. The detailed items for engine include multiple items (specifically, ten items). The process instructing section 51B controls the display unit 55 to display the detailed items for engine and input cells for inputting the appraisal ratings related to the detailed items for engine. The process instructing section 51B obtains the appraisal ratings inputted in the input cells through the input unit 54 operated by the appraiser. The appraisal ratings related to the detailed items for engine are determined according to the five-grade evaluation system, specifically, out of ten points in steps of two points.

The process instructing section 51B calculates an appraisal rating for engine based on the appraisal ratings inputted in the input cells corresponding to the detailed items (hereinafter referred to as an overall engine appraisal rating). For example, the process instructing section 51B calculates the overall engine appraisal rating based on the inputted appraisal ratings and an algorithm for calculating the overall engine appraisal rating. The appraiser performs input operations through the input unit 54 in the user terminal 50 for every time he or she inputs the appraisal ratings for the detailed items for the engine.

If a driving power source of the used vehicle is not an engine but a motor, the process instructing section 51B may control the display unit 55 to display detailed items for the motor and input cells for inputting appraisal ratings related to the detailed items. Then, the process instructing section 51B may calculate the overall motor appraisal rating.

### Frame

Detailed items for frame are illustrated in FIG. 7. The detailed items for frame include multiple items (specifically, twenty one items). The process instructing section 51B controls the display unit 55 to display the detailed items for frame and input cells for inputting the appraisal ratings related to the detailed items for frame. The process instructing section 51B obtains the appraisal ratings inputted in the input cells through the input unit 54 operated by the appraiser. The appraisal ratings related to the detailed items for frame are determined according to the five-grade evaluation system, specifically, out of ten points in steps of two points.

The process instructing section 51B calculates an appraisal rating for frame based on the appraisal ratings inputted in the input cells corresponding to the detailed items (hereinafter referred to as an overall frame appraisal rating). For example, the process instructing section 51B calculates the overall appraisal rating based on the input appraisal ratings and an algorithm for calculating the overall frame appraisal rating. The appraiser performs input operations through the input unit 54 in the user terminal 50 for every time he or she inputs the appraisal ratings for the detailed items for the frame.

### Tire Wear Rate

The process instructing section 51B controls the display unit 55 to display input cells for inputting the appraisal ratings related to tire wear rate of wheels of the used vehicles. The process instructing section 51B accepts the appraisal ratings inputted in the input cells through the input unit 54 operated by the appraiser. The appraisal ratings related to the tire wear rate of the wheels are determined according to the five-grade evaluation system, specifically, out of ten points in steps of two points.

The process instructing section 51B calculates an appraisal rating for tire wear rate based on the appraisal ratings inputted in the input cells corresponding to the tire wear rate (hereinafter referred to as an overall tire wear rate appraisal rating). For example, the process instructing section 51B calculates the overall tire wear rate appraisal rating based on the inputted appraisal ratings and an algorithm for calculating the overall tire wear rate appraisal rating. The appraiser performs input operations through the input unit 54 in the user terminal 50 for every time he or she inputs the appraisal ratings related to the tire wear ratings of the wheels.

### Air Conditioning

The process instructing section 51B controls the display unit 55 to display input cells for inputting the appraisal ratings related to the air conditioning. Examples of the input cells include cells related to temperatures of cold air that blows into a vehicle compartment and to periods from the time when the blowing of air starts to the time when the blowing air temperature that has been decreasing reaches a predefined temperature. The process instructing section 51B obtains the appraisal ratings inputted in the input cells through the input unit 54 operated by the appraiser. The appraisal ratings related to air conditioning are determined according to the five-grade evaluation system, specifically, out of ten points in steps of two points.

The process instructing section 51B calculates an appraisal rating for air conditioning based on the appraisal ratings inputted in the input cells corresponding to the air conditioning (hereinafter referred to as an overall air conditioning appraisal rating). For example, the process instructing section 51B calculates the overall air conditioning appraisal rating based on the inputted appraisal ratings and an algorithm for calculating the overall air conditioning appraisal rating. The appraiser performs input operations through the input unit 54 in the user terminal 50 for every time he or she inputs the appraisal ratings related to the air conditioning.

Returning to the description of FIG. 2, in step S11, the process instructing section 51B instructs the transmitter-receiver section 51A to transmit the appraisal information to the IDC server 60. The appraisal information includes the inputted model information, the generated vehicle age information, the inputted total mileage information, and the overall appraisal ratings for the six main items. The transmitter-receiver section 51A transmits the appraisal information to the IDC server 60 via the communication unit 52 and the communication network 70. The transmitted appraisal information is received by a transmitter-receiver section 61A in the controller 61 via the communication unit 62 in the IDC server 60.

In step S20, a processing section 61B of the controller 61 determines whether the appraisal information is received by the transmitter-receiver section 61A. In step S21, the processing section 61B instructs a data management section 61C of the controller 61 to store the received appraisal information in the memory 63 in response to the determination of the receipt of the appraisal information. The data management section 61C controls the memory 63 to store the received appraisal information. Through the steps, new appraisal information is added to the database in the memory 63.

The greater in number of the used vehicle dealers to which the appraisal information is provided, the greater in number of the user terminals 50. Therefore, a network having a configuration that allows an easy increase in amount of appraisal information stored in the IDC server 60 may be constructed.

### Appraisal Information Update Process by Management Server

Next, an update process will be described. The controller 21 in the management server 20 reads out the program stored in the memory 23 and executes the program. Through the execution of the program, the controller 21 functions as a transmitter-receiver section 21A and an update processing section 21B.

The update processing section 21B periodically (e.g., on a daily basis) and collectively downloads a number of pieces of appraisal information 63A stored in the memory 63 in the IDC server to the memory 23. Specifically, the update processing section 21B transmits an update request to the IDC server 60 via the transmitter-receiver section 21A, the communication unit 22, and the communication network 70.

The update request is inputted to the processing section 61B via the communication unit 62 and the transmitter-receiver section 61A in the IDC server 60. The processing section 61B instructs the transmitter-receiver section 61A to collectively transmit the number of pieces of the appraisal information 63A stored in the memory 63 to the management server 20. The number of pieces of appraisal information 63A is collectively transmit to the management server 20 via the transmitter-receiver section 61A, the communication unit 62, and the communication network 70.

### Used Vehicle Appraising Process

Next, an appraising process will be described. In the management server 20, the controller 21 reads out a program stored in the memory 23 and executes the program. Through the execution of the program, the controller 21 functions as an extracting section 21C, a mean calculating section 21D, a comparative information generating section 21E, a file creating section 21F, and a print instructing section 21G. In the appraising process, mean overall appraisal ratings of multiple used vehicles other than the target vehicle are generated to be used as information that is compared with the overall appraising ratings of the target vehicle. In this embodiment, the controller 21 in the management server 20 corresponds to “an information processing device” and the memory 23 in the management server 20 corresponds to “a memory” that stores a number of pieces of the appraisal information 23A.

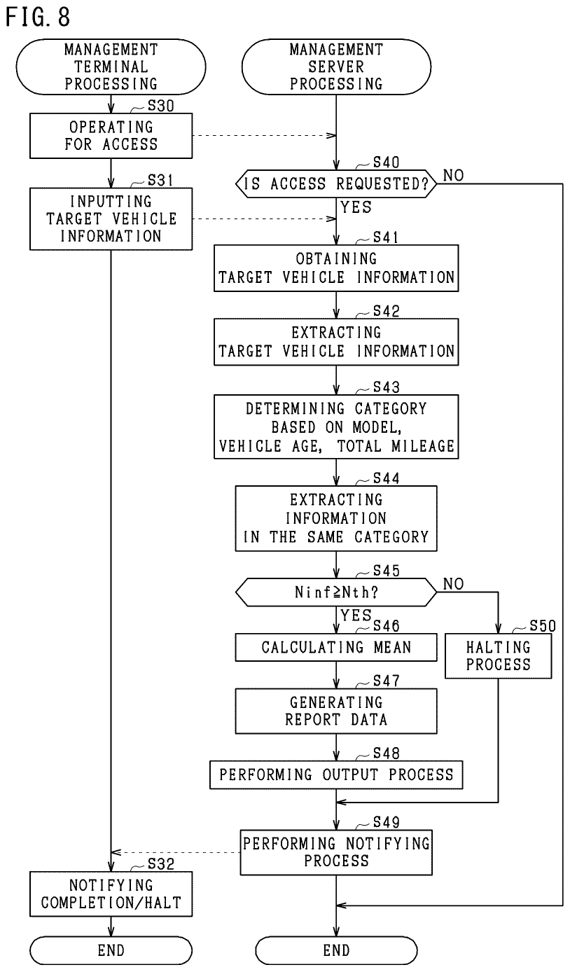

FIG. 8 illustrates a flowchart that indicates steps of the appraising process executed by the management terminal 30 and the management server 20.

In step S30, a process instructing section 31B in the management terminal 30 obtains information through the input unit 34 operated by a representative input and determines whether an access request to access the management server 20 is present based on the obtained information. The process instructing section 31B transmits the access request to the management server 20 via a transmitter-receiver section 31A and the communication unit 32 in response to the determination of presence of the access request. The transmitted access request is received by the transmitter-receiver section 21A via the communication unit 22 in the management server 20.

In step S40, the controller 21 in the management server 20 determines whether the access request is received.

In step S31 after step S30, the process instructing section 31B obtains the information on the target vehicle inputted through the input unit 34 operated by the representative. The display unit 35 displays a screen for selecting the target vehicle from used vehicles that are linked to the appraisal information stored in the memory 23. The process instructing section 31B transmits the obtained information on the target vehicle to the management server 20 via the transmitter-receiver section 31A and the communication unit 32.

The controller 21 in the management server 20 proceeds to step S41 and obtains the received information on the target vehicle in response to the determination of receipt of the access request.

In step S42, the extracting section 21C extracts the appraisal information on the target vehicle from the number of pieces of appraisal information 23A stored in the memory 23 according to the received information on the target vehicle.

In step S43, the extracting section 21C determines a category to which the target vehicle belongs according to category information (specifically, model, vehicle age, and total mileages) included in the extracted appraisal information on the target vehicle.

It is preferable that used vehicles that are compared with the target vehicle are in aging conditions similar to aging condition of the target vehicle. The similarity in aging condition cannot be determined based only on the model year information. As described earlier, the vehicle age information indicates the number of elapsed years since the production of the vehicle until the appraisal of the vehicle. Even if the model years of the used vehicles are the same but the years of the appraisals performed are different, the vehicle ages are different. According to the vehicle age information, vehicles in similar aging conditions to the aging condition of the target vehicle are included in the comparative vehicles.

With the vehicle age information, used vehicles that have different model years are be included in the same category. This increases the number of parameters of the appraisal information for calculating the mean overall ratings and thus relative appraisal of the target vehicle is performed by comparing with the larger number of used vehicles.

The model information includes used vehicle model information for every major change but the used vehicle grade information and used vehicle model information for every minor change. This increases the number of parameters of the appraisal information for calculating the mean overall rating and thus the relative appraisal of the target vehicle is performed by comparing with the larger number of used vehicles.

The extracting section 21C calculates a total mileage range with the total mileage of the target vehicle as the median. The extracting section 21C determines a category to which used vehicles with the same model and the same vehicle age as the target vehicle and with the total mileages within the total mileage range.

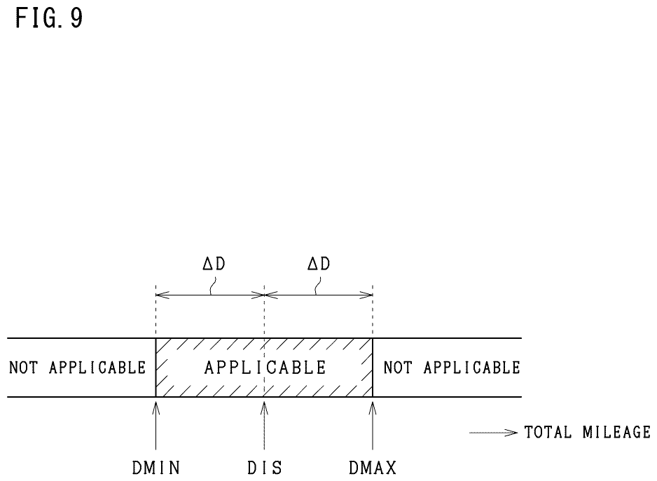

The total mileage range will be described with reference to FIG. 9. In FIG. 9, DIS indicates the total mileage of the target vehicle and ΔD indicates a range. DMIN indicates the lower limit of the total mileage range (=DIS−ΔD) and DMAX indicates the upper limit of the total mileage range (=DIS+ΔD).

For example, if ΔD=8,000 km and DIS=106,000 km, a category to which used vehicles with the total mileage in a range from DMIN of 98,000 km to DMAX of 114,000 km is determined.

Another method for determining the category based on the total mileages according to a predefined mileage interval rather than the total mileage range may be considered. Specifically, it is determined that what range the used vehicle falls among multiple ranges defined based on the predefined mileage interval (e.g., 16,000 km). To select used vehicles with the total mileages similar to the total mileage of the target vehicle for comparison, a reduction in predefined mileage interval may be considered. However, such a reduction may narrow each mileage range and thus the number of the parameters related to the use vehicle appraisal information for the comparison with the target vehicle decreases. An increase in predefined mileage interval may increase the number of parameters but the appraisal information on the used vehicles with the total mileages that are greatly different from the total mileage of the target vehicle may be used.

According to the method using the total mileage range, the number of parameters of the appraisal information for calculating the mean overall appraisal ratings is increased and the used vehicles with the total mileages similar to the total mileage of the target vehicle are included for the comparison.

The difference between the upper limit of the total mileage range and the total mileage DIS is not limited to the same value as the difference between the lower limit of the total mileage range and the total mileage DIS, that is, may be a different value.

Returning to the description of FIG. 8, in step S44, the extracting section 21C extracts multiple pieces (or all) of comparative information that correspond to pieces of the appraisal information on the used vehicles that belong to the determined category from the appraisal information 23A stored in the memory 23. For example, if the model is “TOYOTA:CAMRY (XV50)” and the vehicle age is eight years, the extracting section 21C extracts pieces of the comparative information that correspond to pieces of the appraisal information related to the used vehicles with the total mileages that are within the total mileage range from used vehicles, the model of which is “TOYOTA:CAMRY (XV50)” and the vehicle age of which is eight years among the used vehicles linked to the number of pieces of appraisal information. According to the configuration, the used vehicle appraisal information on the used vehicles in the same category as the target vehicle is automatically extracted.

In step S45, the extracting section 21C determines whether the number Ninf of the extracted pieces of the comparative information is equal to or greater than the predefined number Nth. The predefined number Nth is 2 or greater. For example, the predefined number Nth is an integer within a range from 5 to 20 (specifically, 5, 7, 10, 12, or 15).

In response to the determination of the number Ninf of the extracted pieces of the comparative information equal to or greater than the predefined number Nth, the extracting section 21C proceeds to step S46. In step S46, the mean calculating section 21D performs a mean calculating process for calculating a mean (specifically, a simple mean) of the used vehicle overall appraisal ratings of the used vehicles linked to the pieces of the comparative information based on the extracted pieces of the comparative information. Specifically, the mean calculating section 21D calculates a mean of the overall appraisal ratings for each one of the six main items. For example, if the vehicle exterior overall appraisal ratings of six used vehicles are 6, 4, 4, 6, 2, and 8, a mean of the vehicle exterior overall appraisal ratings is 5 (=(6+4+4+6+2+8)/6).

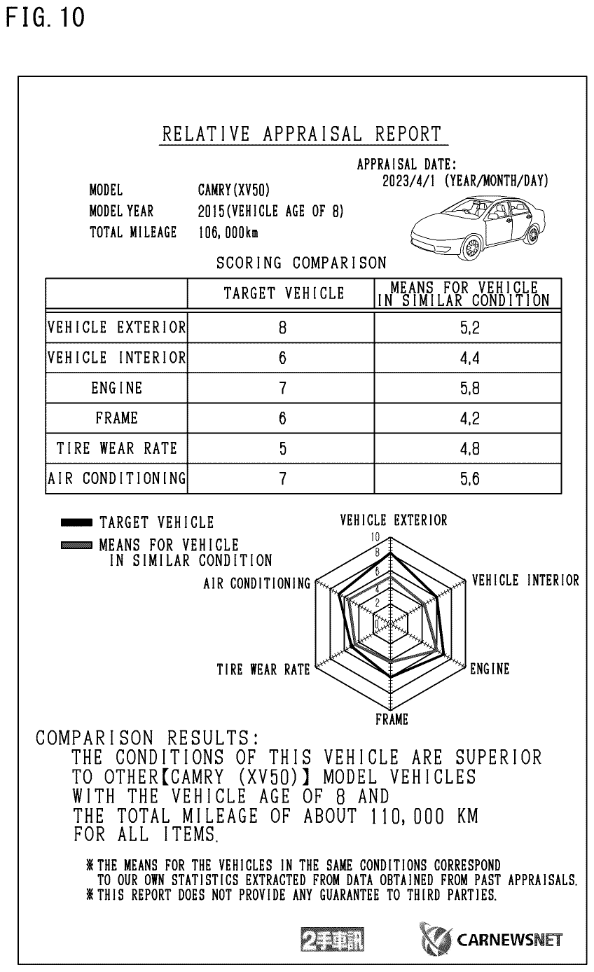

In step S47, the comparative information generating section 21E generates report data that includes information on comparison between the overall appraisal rating of the target vehicle included in the extracted appraisal information on the target vehicle and the calculated mean. In this embodiment, the comparative information generating section 21E generates report data illustrated in FIG. 10. The report data includes information on the following items (B1) to (B5).
(B1) Creation date of the report data
(B2) Model, model year, total mileage, and picture of the target vehicle
(B3) Table indicating comparison between overall appraisal ratings of the target vehicle and calculated means for the main items
(B4) Rader chart indicating comparison between overall appraisal ratings of the target vehicle and calculated means for the main items
(B5) Brief comments on results of the comparisons between the target vehicle and other used vehicles in the same category
(B6) Explanation of the appraisal system 10 and disclaimer

The user of the report data can easily understand the appraisal of the target vehicle relative to the appraisals of the used vehicles in the same category because the user only need to compared the overall appraisal rating of the target vehicle with a single static (a mean). As an alternative to the radar chart in (B4), a bar chart may be used.

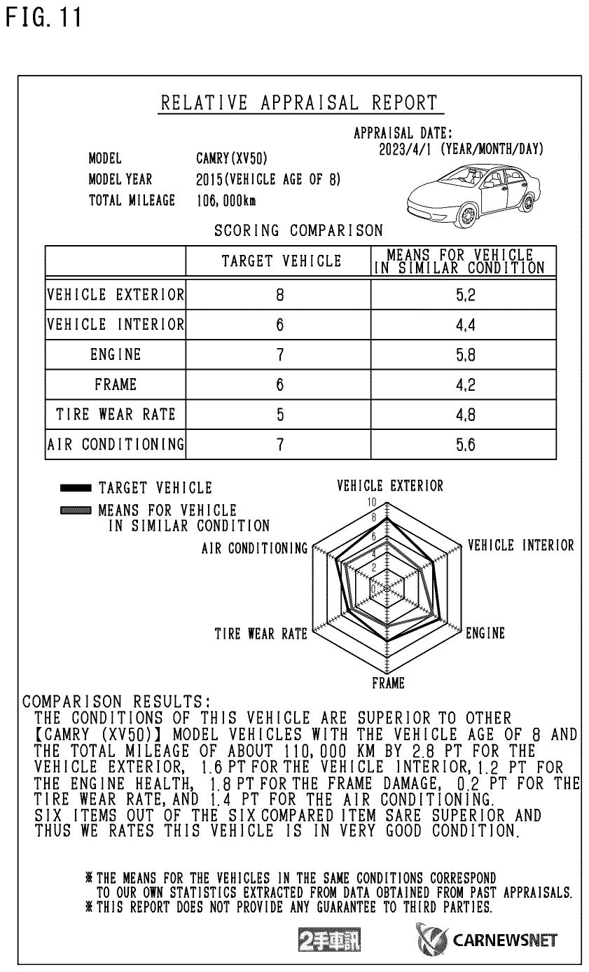

The comparative information generating section 21E may generate report data illustrated in FIG. 11 as an alternative to the report data illustrated in FIG. 10. The brief comments on the results of the comparison illustrated in FIG. 11 includes numerical expressions of information on how much the overall appraisal ratings of the target vehicle are greater than the means for six main items. The comparative information generating section 21E calculates differences between the overall appraisal ratings of the target vehicle and the means for six main items. The comparative information generating section 21E generates information on the calculated differences as the numerical expressions of information. In the example illustrated in FIG. 11, the differences for “Vehicle Exterior,” “Vehicle Interior,” “Engine,” “Frame,” “Tire Wear Rate,” and “Air Conditioner” are “2.8,” “1.6,” “1.2,” “1.8,” “0.2,” and “1.4,” respectively. The comparative information generating section 21E is not required to generate comments on all six main items if the overall appraisal ratings of the target vehicle for any items are determined less than the means.

Returning to the description of FIG. 8, in steps S48 and S49, an output process and a notifying process are performed by at least one of the file creating section 21F and the print instructing section 21G.

First, the output process by the file creating section 21F will be described. In step S48, the file creating section 21F converts the generated report data into electronic data in predefined format (e.g., a PDF file) and stores the electronic data in the memory 23. In step S49, the file creating section 21F performs a process for displaying completion of the output process on the display unit 35 in the management terminal 30 via the transmitter-receiver section 21A and the communication unit 22. If the completion of the output process is displayed on the display unit 35 in step S32, the representative who operates the management terminal 30 downloads the electronic data in predefined format stored in the memory 23 to the memory 33 and sends the electronic data to the user terminal 50 of the used vehicle dealer who has requested the appraisal of the target vehicle or a terminal other than the user terminal 50.

Next, the output process by the print instructing section 21G will be described. In step S48, the print instructing section 21G transmits a printout instruction to print out the generated report data to the management terminal 30. If the process instructing section 31B in the management terminal 30 determines that the instruction to print out is received, the process instructing section 31B instructs the printing device 80 to print out. Then, in step S49, the process instructing section 31B performs a process to display completion of the output process on the display unit 35 in the management terminal 30. The representative who operates the management terminal 30 mails printed paper report to the used vehicle dealer who has requested the appraisal of the target vehicle.

If the number Ninf of the extracted pieces of the comparative information is less than the predefined number Nth, the extracting section 21C proceeds to step S50. In step S50, the controller 21 halts the mean calculating process and the repot data generating process. Therefore, the appraisal of the target vehicle relative to other used vehicles is less likely to be performed when only a small number of parameters of the other used vehicles are provided.

A single vehicle may be on the market for several times and the appraisal may be performed on the vehicle for several times. In such a case, information on multiple appraisals of a single used vehicle is stored in the IDS server 60 through a registering process. If the multiple appraisals have been performed in different years for the single used vehicle, the vehicle ages in the appraisals are different from one another. Because multiple pieces of information on the multiple appraisals of the single used vehicle including different vehicle ages are registered in the database, the appraisal information that enables proper comparison with the target vehicle is provided.

According to the embodiment described above, proper appraisal information on used vehicles is generated for potential buyers of used vehicles.

### Other Embodiments

The embodiment described above may be modified as described below.

In step S48 illustrated in FIG. 8, the file creating section 21F may store the report data converted into the predefined format in the memory 63 in the IDC server 60 as an alternative to or in addition to the memory 23 in the management server 20. In this configuration, the user terminal 50 of the used vehicle dealer who has requested the appraisal of the target vehicle or a terminal other than the user terminal 50 may access the IDC server 60 to view the report data or to download the report data.

In step S43 illustrated in FIG. 8, a method for determining the category based on a predefined mileage interval may be used as described below as an alternative to the method for determining the category based on the total mileage. If the predefined mileage interval is set to 16,000 km, ranges Cdis (i) that are determined based on the total mileage are “0 km≤Cdis (1)<16,000 km,” “16,000 km≤Cdis (2)<32,000 km,” . . . , “176,000 km≤Cdis (12)<192,000 km.” The extracting section 21C determines a range, within which the total mileage of the target vehicle falls and then determines a category that includes used vehicles in the determined range.

In step S43, a method described blow may be used for determining the category based on the vehicle age information. The extracting section 21C calculates a vehicle age range with the vehicle age OD of the target vehicle as a median. Specifically, the extracting section 21C calculates a vehicle age range (between OD−ΔA and OD+ΔB) with the vehicle age OD of the target vehicle as a median. For example, if the vehicle age is 5 years and each of ΔA and ΔB is 1 year, the extracting section 21C determines the category that includes the used vehicles in the vehicle age of 4 to 6 years. ΔA and ΔB are not limited to the same value, that is, may be different values.

In step S10 illustrated in FIG. 2, year and month of production of the vehicle rather than year of production of the vehicle may be included in the model year information. Appraisal year and month information may be used as an alternative to the appraisal year information. In this configuration, the process instructing section 51B in the user terminal 50 may generate information on elapsed months since the production of the vehicle until the appraisal of the vehicle. In this configuration, the category may be determined in step 43 based on the vehicle age range (between OD−ΔA and OD+ΔB) with the vehicle age OD of the target vehicle as the median. In this configuration, each of ΔA and ΔB may be set to a month or months.

In step S43, the category may be determined based on the model year information as an alternative to the vehicle age information.

In step S46, the highest ratings, the lowest ratings, and the medians of the overall ratings may be calculated as an alternative to the calculation of the means of the overall ratings. In this configuration, the report data in step S47 should include information on comparison of the overall ratings of the target vehicle with the highest rating, the lowest rating, and the median of the overall appraisal ratings of the used vehicles in the category to which the target vehicle belongs.

The vehicle age information may be generated by the IDC server 60 rather than by the user terminal 50. In this configuration, the model year information or (A2) and the appraisal year information (A3) are transmitted from the user terminal 50 to the IDC server 60.

The category information used in the appraisal information registering process may further include optional information that may be related to at least one of information on geographical areas in which the used vehicles have been used (hereinafter referred to as geographical area information), information on whether the used vehicles are smoking vehicles (hereinafter referred to as smoking vehicle information), and the number of previous owners of each used vehicle (hereinafter referred to as the number of owners information). In step S10 illustrated in FIG. 2, the input screen for inputting the appraisal information in the display unit 55 may include input cells for inputting the geographical area information, the smoking vehicle information, and the number of owners information, respectively. The geographical area information may include information on prefectures in which the vehicles have been used, information on whether the geographical areas are snowy areas, and information on whether the geographical areas are coastal areas.

For example, if the target vehicle is a smoking vehicle, the extracting section 21C of the management server 20 extracts the appraisal information on smoking vehicles among the used vehicles with the same model and the same vehicle age as the target vehicle and have total mileages in the total mileage range.

Even if the target vehicle has a negative factor such as a smoking vehicle, the repot data that indicates how much the target vehicle is superior or inferior to smoking vehicles that have the same negative factor as the target vehicle can be generated.

Models may be classified based on before and after minor changes rather than major changes. In this configuration, the model information may include information on models of the used vehicles for every minor change.

The controller 21 in the management server 20 may receive the appraisal information 63A stored in the memory 63 in the IDC server 60 rather than the memory 23 in the management server 20, and then may perform steps S41 to S50 illustrated in FIG. 8 based on the received appraisal information.

A main device to perform the used vehicle appraising process is not limited to the management server 20.

Steps S41 to S50 illustrated in FIG. 8 may be performed by the controller 31 in the management terminal 30 rather than the controller 21 in the management server 20. In this configuration, the controller 31 in the management terminal 30 corresponds to “an information processing device.” The controller 31 in the management terminal 30 may receive the appraisal information 23A stored in the memory 23 in the management server 20 from the management server 20. The controller 31 in the management terminal 30 may receive the appraisal information 63A stored in the memory 63 in the IDC server 60 from the IDC server 60 rather than the memory 23 in the management server 20.

Steps S41 to S50 illustrated in FIG. 8 may be performed by the controller 51 in the user terminal 50 rather than the controller 21 in the management server 20. In this configuration, the controller 51 in the user terminal 50 corresponds to “an information processing device.” The controller 51 in the user terminal 50 may receive the appraisal information 23A stored in the memory 23 in the management server 20 from the management server 20 or may receive the appraisal information 63A stored in the memory 63 in the IDC server 60 from the IDC server 60, and then perform steps S41 to S50 illustrated in FIG. 8 based on the received appraisal information.

The vehicle age information or the total mileage information may not be included in the category information.

The management terminal 30 may be a smartphone or a tablet computer.

The user terminal 50 may be a laptop computer or a desktop computer.

The present disclosure has been described with reference to the embodiments; however, it should be understood that the present disclosure is not limited to the embodiments or structures. The present disclosure includes various modified embodiments and modifications within the scope of equivalents. Further, various combinations and configurations that includes only one element, alternatively, more than one or less than one element may be within the scope and idea of the present disclosure.

What is claimed is:

1. A used vehicle appraisal system comprising:
a memory; and
an information processing device that is communicably connected to the memory, wherein
the memory stores a number of pieces of appraisal information that includes appraisal ratings of used vehicles linked to category information on the used vehicles,
the category information includes categories to which the used vehicles belongs, wherein the categories include:
a category of used vehicle model; and
a category of elapsed period since production of a vehicle until an appraisal of the vehicle,
the appraisal ratings are for at least two of main items for appraisal including used vehicle exterior, used vehicle interior, engine or motor in the used vehicle, used vehicle frame, used vehicle tire wear rate, and used vehicle air conditioning,
the information processing device performs:
a determining process for determining a category of the used vehicles, an elapsed period of which is the same as a target vehicle, as a category to which the target vehicle belongs based on information on the elapsed period regardless of model years of the used vehicles;
an extracting process for extracting pieces of comparative information that corresponds to pieces of the appraisal information on the used vehicles that belongs to the category from the appraisal information stored in the memory and determining whether the number of the pieces of the comparative information is two or greater than a predefined number;
in response to determination of the number of the pieces of the comparative information greater than the predefined number, a statistics calculating process for calculating statistics of the appraisal ratings of the used vehicles linked to the pieces of the comparative information based on the pieces of the comparative information for the main items, respectively;
an information generating process for generating information on comparisons between the appraisal ratings of the target vehicle and the statistics for the main items, respectively; and
in response to determination of the number of the pieces of the comparative information less than the predefined number, a halting process for halting the statistics calculating process and the information generating process.

2. The used vehicle appraisal system according to claim 1, wherein
the memory stores pieces of the appraisal information related to appraisals that have been performed on the same used vehicle for multiple times in the past an include the appraisal information with different elapsed periods, and
in the extracting process, the information processing device extracts the comparative information from the appraisal information that incudes pieces of the appraisal information with the different elapsed periods for the same used vehicle stored in the memory.

3. The used vehicle appraisal system according to claim 1, wherein
the category of used vehicle model is classified based on used vehicle models for every major change or for every minor change, and
in the determining process, the information processing device determines a category to which the used vehicles with the same model as the target vehicle for every major change or for every minor change.

4. The used vehicle appraisal system according to claim 1, wherein
the category information includes the used vehicle total mileage information,
in the determining process, the information processing device:
calculates a total mileage range with a total mileage of the target vehicle as a median, and
determines a category to which the used vehicles having total mileages within the total mileage range belong.

5. The used vehicle appraisal system according to claim 3, wherein
the category information includes the used vehicle total mileage information,
in the determining process, the information processing device:
calculates a total mileage range with a total mileage of the target vehicle as a median; and
determines a category to which the used vehicles having total mileages within the total mileage range belong.

6. The used vehicle appraisal system according to claim 1, wherein
the memory stores the appraisal information on the target vehicle,
the category information includes:
a category of used vehicle model year; and
a category of used vehicle total mileage,
in the information generating process, the information processing device generates information based on the appraisal information on the target vehicle stored in the memory and the statistics, the information that is generated includes:
the target vehicle model, model year, and total mileage;
at least one of a table and a graph that indicate comparison between appraisal ratings of the target vehicle and the statistics for main items, respectively; and
a comment that describes results of a comparison of the target vehicle relative to the used vehicles in the category.

7. The used vehicle appraisal system according to claim 6, wherein
based on the appraisal information on the target vehicle stored in the memory and the statistics, the information processing device:
calculates differences between the appraisal ratings of the target vehicle and the statistics for the main items, respectively; and
includes information generated based on the differences in the comment that describes the results of the comparison, wherein the information includes numerical expressions that indicates how much the target vehicle is greater than the used vehicles in the category.

8. The used vehicle appraisal system according to claim 6, wherein in the statistics calculating process, the information processing device calculates means for the statistics.

9. The used vehicle appraisal system according to claim 1, further comprising user terminals that are operated by operators who perform used vehicle appraisals and communicably connected to the information processing device, wherein
the user terminals include input units that are operated by the operators to input the appraisal information in the used vehicle appraisals,
the user terminals performs:
an appraisal information obtaining process for obtaining the appraisal information inputted through an input units with which input operations are performed; and
an appraisal information transmitting process for transmitting the appraisal information that is obtained to the information processing device, and
the information processing device performs an appraisal information storing process for storing the appraisal information received from the user terminals in the memory.

10. The used vehicle appraisal system according to claim 1, wherein the information processing device does not perform the statistics calculating process and the information generating process if the number of pieces of the comparative information that is extracted is less than a predefined number even if the information process device is able to calculate the statistics.

11. An information processing device that performs appraisals of used vehicle based on information stored in a memory, wherein
the memory stores a number of pieces of appraisal information that include appraisal ratings of the used vehicles linked to category information on the used vehicles,
the category information includes categories to which the used vehicles belongs, wherein the categories include:
a category of used vehicle model; and
a category of elapsed period based on elapse years or elapsed months since production of a vehicle until an appraisal of the vehicle, and
the appraisal ratings are for at least two of main items for appraisal including used vehicle exterior, used vehicle interior, engine or motor in the used vehicle, used vehicle frame, used vehicle tire wear rate, and used vehicle air conditioning,
the information processing device performs:
a determining process for determining a category of the used vehicles, an elapsed period of which is the same as a target vehicle, as a category to which the target vehicle belongs based on information on the elapsed period regardless of model years of the used vehicles;
an extracting process for extracting pieces of comparative information that corresponds to pieces of the appraisal information on the used vehicles that belongs to the category from the appraisal information stored in the memory and determining whether the number of the pieces of the comparative information is two or greater than a predefined number;
in response to determination of the number of the pieces of the comparative information greater than the predefined number, a statistics calculating process for calculating statistics of the appraisal ratings of the used vehicles linked to the pieces of the comparative information based on the pieces of the comparative information for the main items, respectively;
an information generating process for generating information on comparisons between the appraisal ratings of the target vehicle and the statistics for the main items, respectively; and
in response to determination of the number of the pieces of the comparative information less than the predefined number, a halting process for halting the statistics calculating process and the information generating process.

12. The information processing device according to claim 11, wherein
the memory stores pieces of the appraisal information related to appraisals that have been performed on the same used vehicle for multiple times in the past an include the appraisal information with different elapsed periods, and
in the extracting process, the information processing device extracts the comparative information from the appraisal information that incudes pieces of the appraisal information with the different elapsed periods for the same used vehicle stored in the memory.

13. A method used for a used vehicle appraisal system that includes a memory and a processor, wherein
the memory stores a number of pieces of appraisal information that includes appraisal ratings of used vehicles linked to category information on the used vehicles,
the category information includes categories to which the used vehicles belongs, wherein the categories include:
a category of used vehicle model; and
a category of elapsed period based on elapse years or elapsed months since production of a vehicle until an appraisal of the vehicle,
the appraisal ratings are for at least two of main items for appraisal including used vehicle exterior, used vehicle interior, engine or motor in the used vehicle, used vehicle frame, used vehicle tire wear rate, and used vehicle air conditioning, the method comprising causing the processor to executes:
a determining process for determining a category of the used vehicles, an elapsed period of which is the same as a target vehicle, as a category to which the target vehicle belongs based on information on the elapsed period regardless of model years of the used vehicles;
an extracting process for extracting pieces of comparative information that corresponds to pieces of the appraisal information on the used vehicles that belongs to the category from the appraisal information stored in the memory and determining whether the number of the pieces of the comparative information is two or greater than a predefined number;
in response to determination of the number of the pieces of the comparative information greater than the predefined number, a statistics calculating process for calculating statistics of the appraisal ratings of the used vehicles linked to the pieces of the comparative information based on the pieces of the comparative information for the main items, respectively;
an information generating process for generating information on comparisons between the appraisal ratings of the target vehicle and the statistics for the main items, respectively; and
in response to determination of the number of the pieces of the comparative information less than the predefined number, a halting process for halting the statistics calculating process and the information generating process.

14. The method according to claim 13, wherein
the memory stores pieces of the appraisal information related to appraisals that have been performed on the same used vehicle for multiple times in the past an include the appraisal information with different elapsed periods, and
in the extracting process, the comparative information is extracted from the appraisal information that incudes pieces of the appraisal information with the different elapsed periods for the same used vehicle stored in the memory.
